(19) United States
(12) Patent Application Publication
(10) Pub. No.: US 2016/0214528 A1
(43) Pub. Date: Jul. 28, 2016

(54) VEHICULAR BRAKING INDICATOR SYSTEM AND METHOD FOR DISPLAYING MAGNITUDE OF BRAKE ENGAGEMENT

(71) Applicant: Darren Eastman, Los Angeles, CA (US)

(72) Inventor: Darren Eastman, Los Angeles, CA (US)

(21) Appl. No.: 14/606,482

(22) Filed: Jan. 27, 2015

(51) Int. Cl. B60Q 1/44; B60T 7/04

(52) U.S. Cl. CPC B60Q 1/444; B60T 7/042

(57) ABSTRACT

A reactive vehicular braking indicator system and method enhances user safety by displaying a magnitude of brake engagement in a braking system of a vehicle based on a degree of pedal depression. The system includes a sensor connected to a braking system pedal to determine a current pedal depression travel distance, a microprocessor coupled to the vehicle and operably connected to the sensor, the microprocessor able to determine a ratio equal to the current pedal depression travel distance to a fully depressed pedal travel distance, and a lighting system having a plurality of lights coupled to the vehicle. The lighting system is connected to the microprocessor and able to enable one or more of the plurality of lights to activate in a pattern corresponding to the ratio determined by the microprocessor, thereby enabling the activated lights to display the magnitude of brake engagement of the vehicle.

### BACKGROUND

The embodiments herein relate generally to vehicular brake external lighting systems.

Vehicular braking systems typically comprise a series of brake lights affixed to the rear of the vehicle, which illuminate when the driver engages the vehicle's brakes. These brake lights help to reduce rear end collisions between vehicles by notifying a trailing vehicle's driver to slow down when the brake lights of a leading vehicle illuminate.

However, these existing brake lighting systems are limited in use and pose several risks to drivers. In these systems, the series of brake lights illuminate simultaneously when the brake pedal is depressed and/or the brakes engage with the vehicle's wheels, and disable simultaneously when the brake pedal is released and the brakes disengage with the vehicle's wheels. As a result, these brake lights can mislead trailing drivers about the speed and dynamics of the leading vehicle.

Specifically, a trailing vehicle's driver cannot determine the magnitude of brake engagement of a leading vehicle by viewing the brake lights alone. This can be especially problematic in emergency situations when vehicles traveling at high speeds on roadways suddenly stop. In this situation, a trailing driver may misinterpret the illuminating brake lights of the leading vehicle to suggest a minimal engagement of the brakes. Brake tail lights can further mislead drivers because the majority of vehicular braking systems illuminate brake lights when the brake pedal is slightly depressed. In this state, the brakes have not engaged and the pedal is required to be depressed further to engage the brakes with the vehicle's wheels. For these reasons, current vehicular brake lights do not adequately inform other drivers of the speed and dynamics of a vehicle. This can cause drivers to misjudge traffic with other vehicles, which increases the incidence of vehicular collisions and injuries or death to individuals.

As such, there is a need in the industry for a reactive vehicular braking indicator system and method that displays the braking intensity of a vehicle to others, thereby enhancing user and vehicle safety.

### SUMMARY

A reactive vehicular braking indicator system and method is configured to enhance user safety by displaying a magnitude of brake engagement in a braking system of a vehicle based on a degree of pedal depression. The vehicular braking indicator system comprises a sensor operably connected to a pedal of the braking system and configured to determine a current pedal depression travel distance, a microprocessor coupled to the vehicle and operably connected to the sensor, the microprocessor configured to determine a ratio equal to the current pedal depression travel distance to a fully depressed travel distance of the pedal, and a lighting system comprising a plurality of lights coupled to the vehicle, the lighting system being operably connected to the microprocessor and configured to enable one or more of the plurality of lights to activate in a pattern corresponding to the ratio determined by the microprocessor, thereby enabling the activated lights to display the magnitude of brake engagement of the vehicle.

In certain embodiments of the invention, the reactive vehicular braking indicator method comprises activating a sensor operably connected to a pedal of the braking system, determining a current pedal depression travel distance of the pedal based on a measurement completed by the sensor, generating brake data including at least a first ratio equal to the current pedal depression travel distance to a fully depressed travel distance of the pedal, and operating a lighting system comprising a plurality of lights affixed to the vehicle based on the brake data, wherein the operation of the lighting system permits one or more of the plurality of lights to activate in a pattern corresponding to the first ratio, thereby enabling the activated lights to display the magnitude of brake engagement of the vehicle. In certain embodiments, the method comprises determining a subsequent pedal depression travel distance of the pedal based on a measurement completed by the sensor, generating a second ratio equal to the subsequent pedal depression travel distance to the fully depressed travel distance of the pedal, and operating the lighting system to permit one or more of the plurality of lights to activate in a pattern corresponding to the second ratio if the difference between the first ratio and the second ratio comprises a value within a predetermined range of values.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a schematic view of certain embodiments of the reactive vehicular braking indicator system;

FIG. 2 depicts a schematic view of certain embodiments of the reactive vehicular braking indicator system;

FIG. 3 depicts a schematic view of an alternate embodiment of the reactive vehicular braking indicator system;

FIG. 4 depicts a schematic view of an alternate embodiment of the reactive vehicular braking indicator system;

FIG. 5 depicts a flowchart of a method for displaying a magnitude of brake engagement in a braking system of a vehicle in accordance with certain embodiments of the invention; and

FIG. 6 depicts a flowchart of a method for displaying a magnitude of brake engagement in a braking system of a vehicle in accordance with certain embodiments of the invention.

### DETAILED DESCRIPTION OF CERTAIN EMBODIMENTS

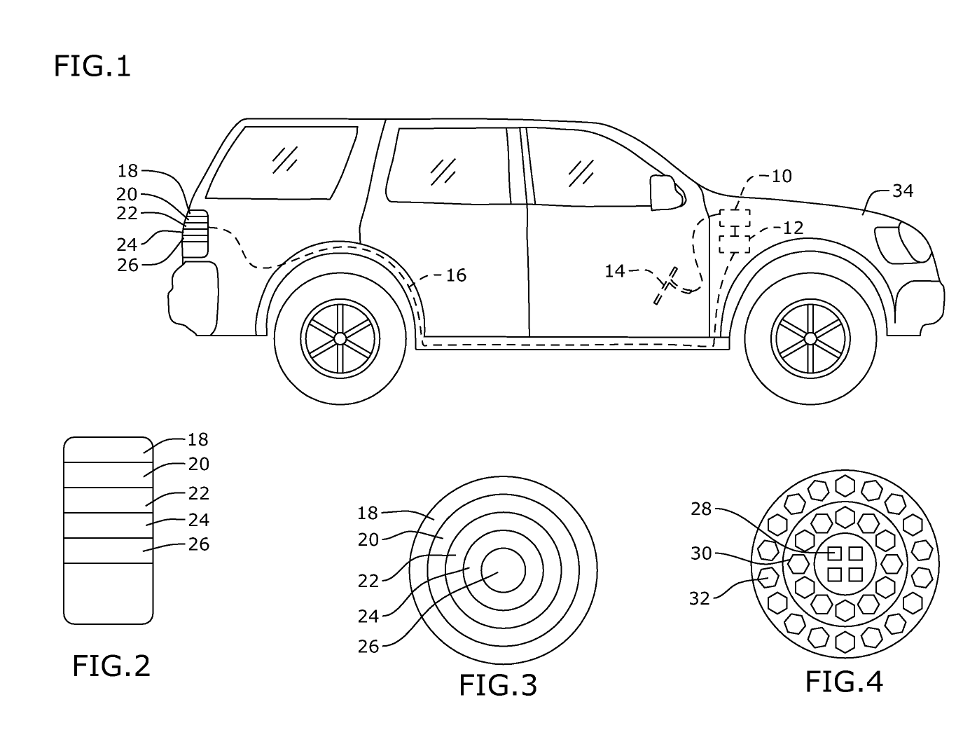

As depicted in FIG. 1, the reactive vehicular braking indicator system is configured for use with vehicle 34 and comprises microprocessor 10, brake controller 12, brake pedal 14 and brake indicator lights 18, 20, 22, 24 and 26. Vehicle 34 is typically an automobile or truck. However, vehicle 34 may also be any alternative vehicle including, but not limited to, fork lifts, tractors, boats, trains, or the like. Brake pedal 14 is affixed to the interior cabin of vehicle 34 and is operably connected to brake controller 12 and microprocessor 10 by wires. It shall be appreciated that brake pedal 14 and brake controller 12 may be used with any type of braking system known in the field such as disk brakes and drum brakes. This braking system comprises any components known in the field including, but not limited to, anti-lock systems, master cylinders, tubes and hoses, and the like.

Microprocessor 10 is operably connected to brake indicator lights 18, 20, 22, 24 and 26 by wire 16. Microprocessor 10 transmits signals via wire 16 to brake indicator lights 18, 20, 22, 24 and 26 to permit the brake indicator lights to turn on and off as desired. Alternatively, microprocessor 10 can communicate with the brake indicator lights by using a wireless communication system. Microprocessor 10 is typically part of an application-specific integrated circuit (ASIC) and comprises a memory storage unit comprising an algorithm and/or executable processing instructions required to implement the functionality of the reactive vehicular braking indicator system.

In a preferred embodiment, a sensor (not shown) is operably connected to brake pedal 14 and microprocessor 10. The sensor calculates the travel distance pedal 14 is depressed at any given time and transmits this value to microprocessor 10. Microprocessor 10 calculates a brake pedal depression ratio that is equal to the current depression travel distance of pedal 14 to a fully depressed travel distance of pedal 14. The fully depressed travel distance of pedal 14 is a known value, which is inputted into microprocessor 10. Microprocessor 10 transmits operating instruction signals to brake indicator lights 18, 20, 22, 24 and 26, which enables the brake indicator lights to illuminate in a pattern corresponding to the brake pedal depression ratio. As a result, the activated brake indicator lights display the magnitude of brake engagement of vehicle 34 to other vehicles, drivers and pedestrians.

Brake indicator lights 18, 20, 22, 24 and 26 are affixed to the rear of vehicle 34 and may comprise various configurations as depicted in FIGS. 2-4. The brake indicator lights may use any types of bulbs including light-emitting diodes (LED) or standard filament bulbs. As depicted in FIG. 2, brake indicator lights 18, 20, 22, 24 and 26 are disposed in a plurality of rectangular compartments stacked vertically together. As depicted in FIG. 3, brake indicator lights 18, 20, 22, 24 and 26 are disposed in a plurality of concentric circle compartments. In either configuration, the brake indicator lights illuminate in a pattern corresponding to the brake pedal depression ratio.

For example, a 60% brake depression ratio enables brake indicator lights 26, 24 and 22 to flash in a sequential pattern that may be repeated so long as pedal 14 remains depressed in this state. In contrast, a 100% brake depression ratio enables brake indicator lights 26, 24, 22, 20 and 18 to flash in a sequential pattern. The flash rate in which each subsequent brake indicator light illuminates depends on the magnitude of brake engagement. For example, a 100% brake depression ratio causes brake indicator lights 26, 24, 22, 20 and 18 to sequentially illuminate at a quicker rate than the rate for brake indicator lights 26, 24 and 22 to sequentially illuminate at a 60% brake depression ratio. FIG. 3 depicts an alternative arrangement of brake indicator lights 28, 30 and 32, which may comprise a plurality of distinct light bulbs disposed in each compartment. It shall be appreciated that any alternative arrangement and number of brake indicator lights may be used instead.

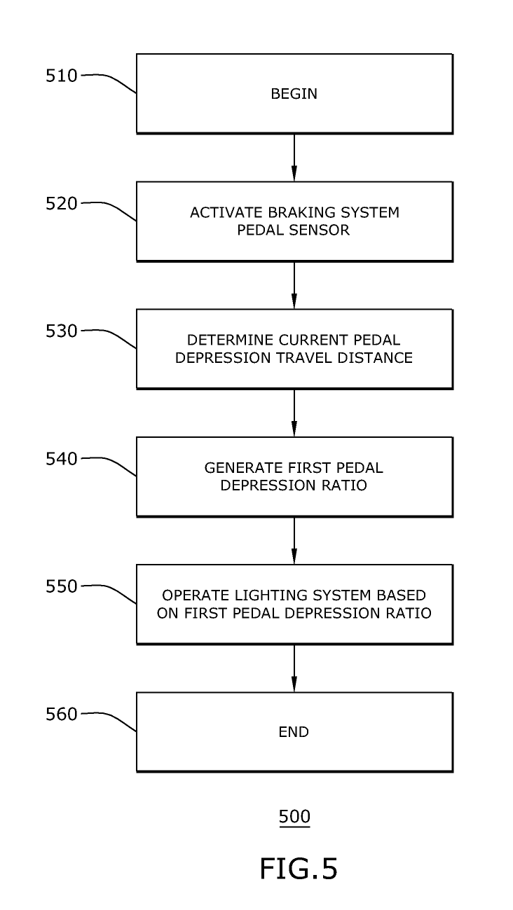

FIG. 5 depicts a flowchart of a method for displaying a magnitude of brake engagement in a braking system of a vehicle in accordance with certain embodiments of the invention. The method 500 begins at step 510. Method 500 is described with reference to the system described above. As step 520, the sensor connected to pedal 14 is activated. At step 530, the sensor calculates the current pedal depression travel distance of pedal 14. This occurs typically when a driver of vehicle 34 depresses pedal 14 with his/her foot. The current pedal depression travel distance is transmitted to microprocessor 10. At step 540, microprocessor 10 generates a first pedal depression ratio that is equal to the current pedal depression travel distance of pedal 14 to a fully depressed travel distance of pedal 14. Microprocessor 10 then transmits operating instruction signals to brake indicator lights 18, 20, 22, 24 and 26 corresponding to the first pedal depression ratio. At step 550, the lighting system comprising brake indicator lights 18, 20, 22, 24 and 26 are operated based on the first pedal depression ratio. This enables the brake indicator lights to activate in a pattern corresponding to the first brake pedal depression ratio. As a result, user and vehicular safety is enhanced because other vehicles, drivers and pedestrians can determine the magnitude of brake engagement of vehicle 34 based on the activated brake indicator lights. The method concludes at step 560.

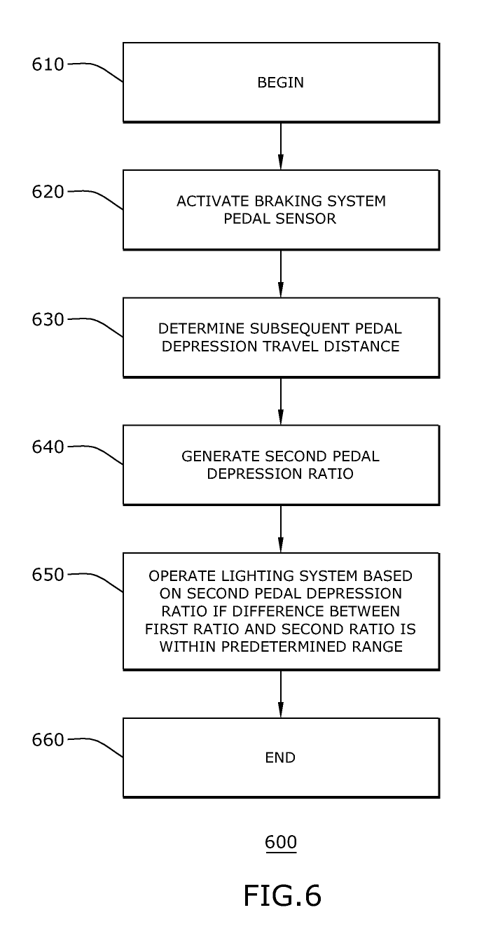

In certain embodiments of the invention, the reactive vehicular braking indicator method can operate in real-time to continually monitor the state of brake pedal 14 and update brake indicator lights 18, 20, 22, 24 and 26 as needed. FIG. 6 depicts a flowchart of a method demonstrating asynchronous communications between brake indicator lights 18, 20, 22, 24 and 26, and microprocessor 10 during an update procedure.

The method 600 begins at step 610. At step 620, the sensor connected to pedal 14 is activated. The sensor may already be activated, which typically is the case when the engine of vehicle 34 is in an operational mode. At step 630, the sensor calculates a subsequent pedal depression travel distance of pedal 14. The subsequent pedal depression travel distance is transmitted to microprocessor 10. At step 640, microprocessor 10 generates a second pedal depression ratio that is equal to the subsequent pedal depression travel distance of pedal 14 to a fully depressed travel distance of pedal 14. Microprocessor 10 computes a differential value between the first pedal depression ratio and the second pedal depression ratio. If the differential value falls within a predetermined range, step 650 is completed. Otherwise, the method concludes at step 660. At step 650, the lighting system comprising brake indicator lights 18, 20, 22, 24 and 26 are activated in a pattern corresponding to the second pedal depression ratio. Since the brake indicator lights operate based on the second pedal depression ratio only if the differential value falls within a predetermined range, the sequential flashing pattern of brake indicator lights 18, 20, 22, 24 and 26 will not be updated for minimal changes to the brake pedal depression travel distance. The method concludes at step 660.

It shall be appreciated that method 600 may be repeated any number of times at variable time interval frequencies to permit the reactive vehicular braking indicator method to operate in real-time. As such, the method will continually determine subsequent pedal depression travel distances and compare subsequent pedal depression ratios to previous pedal depression ratios to determine whether to alter the operation of brake indicator lights 18, 20, 22, 24 and 26.

It shall be appreciated that the components of the reactive vehicular braking indicator system and method described in several embodiments herein may comprise any alternative known materials/components in the field and be of any color, size and/or dimensions. It shall be appreciated that the components of the reactive vehicular braking indicator system described herein may be manufactured and assembled using any known techniques in the field.

Persons of ordinary skill in the art may appreciate that numerous design configurations may be possible to enjoy the functional benefits of the inventive systems and methods. Thus, given the wide variety of configurations and arrangements of embodiments of the present invention the scope of the invention is reflected by the breadth of the claims below rather than narrowed by the embodiments described above.

What is claimed is:

1. A reactive vehicular braking indicator system configured to enhance user safety by displaying a magnitude of brake engagement in a braking system of a vehicle based on a degree of pedal depression, the vehicular braking indicator system comprising:
a sensor operably connected to a pedal of the braking system and configured to determine a current pedal depression travel distance;
a microprocessor coupled to the vehicle and operably connected to the sensor, the microprocessor configured to determine a ratio equal to the current pedal depression travel distance to a fully depressed travel distance of the pedal; and
a lighting system comprising a plurality of lights coupled to the vehicle, the lighting system being operably connected to the microprocessor and configured to enable one or more of the plurality of lights to activate in a pattern corresponding to the ratio determined by the microprocessor, thereby enabling the activated lights to display the magnitude of brake engagement of the vehicle.

2. The reactive vehicular braking indicator system of claim 1, wherein the plurality of lights of the lighting system are disposed within a plurality of concentric circle compartments coupled to the vehicle.

3. The reactive vehicular braking indicator system of claim 1, wherein the plurality of lights of the lighting system are disposed within a plurality of rectangular compartments stacked together and coupled to the vehicle.

4. A reactive vehicular braking indicator method enhances user safety by displaying a magnitude of brake engagement in a braking system of a vehicle based on a degree of pedal depression, the method comprising:
activating a sensor operably connected to a pedal of the braking system;
determining a current pedal depression travel distance of the pedal based on a measurement completed by the sensor;
generating brake data including at least a first ratio equal to the current pedal depression travel distance to a fully depressed travel distance of the pedal; and
operating a lighting system comprising a plurality of lights affixed to the vehicle based on the brake data, wherein the operation of the lighting system permits one or more of the plurality of lights to activate in a pattern corresponding to the first ratio, thereby enabling the activated lights to display the magnitude of brake engagement of the vehicle.

5. The reactive vehicular braking indicator method of claim 4, further comprising:
determining a subsequent pedal depression travel distance of the pedal based on a measurement completed by the sensor;
generating a second ratio equal to the subsequent pedal depression travel distance to the fully depressed travel distance of the pedal; and
operating the lighting system to permit one or more of the plurality of lights to activate in a pattern corresponding to the second ratio if the difference between the first ratio and the second ratio comprises a value within a predetermined range of values.
